(19) United States
(12) Patent Application Publication
(10) Pub. No.: US 2007/0041570 A1
(43) Pub. Date: Feb. 22, 2007

(54) Method and apparatus for setting user-based one-touch dials in a fax machine or multi-function product having a fax function

(75) Inventors: Seung-Soo Lee, Suwon-si (KR); Sang-Hyup Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/493,638

(22) Filed: Jul. 27, 2006

(30) Foreign Application Priority Data
Aug. 16, 2005 (KR) 10-2005-0074923

(51) Int. Cl. H04M 1/00; H04M 3/00

(52) U.S. Cl. 379/355.01

(57) ABSTRACT

A method and apparatus are provided for setting one-touch dials corresponding to keys for each user in a fax machine or multi-function product (MFP) having a fax function. The method includes identifying a user, searching a storage unit storing user-based one-touch dial information, reading one-touch dial information corresponding to the identified user, and matching one-touch dials with keys using the read one-touch dial information. Accordingly, when a fax is transmitted by using a fax machine or MFP that a plurality users share, the number of available one-touch dials can be increased by using a one-touch dial and setting one-touch dials corresponding to keys for each user.

### PRIORITY

This application claims the benefit under 35 U.S.C. §119(a) of Korean Patent Application No. 10-2005-0074923, filed Aug. 16, 2005, in the Korean Intellectual Property Office, the entire disclosure of which is hereby incorporated by reference.

### BACKGROUND OF THE INVENTION

1. Field of the Invention

The present invention relates to a fax machine or multi-function product (MFP) having a fax function. More particularly, the present invention relates to a method and apparatus for setting one-touch dials by one-to-one matching fax numbers with installed keys.

2. Description of the Related Art

In general, a fax machine or multi-function product (MFP) having a fax function is used in an office or home to transmit or receive various documents. A fax machine or MFP having a fax function has buttons on which digits from 0 to 9 are displayed to input a fax number. Fax numbers that are frequently used are pre-set to the buttons as one-touch dials. Thus, a user can input a full fax number using the buttons or conveniently input a fax number by pressing a one-touch dial if the fax number is set thereto.

Since the number of buttons that can be included on a fax machine or MFP having a fax function is limited, the number of one-touch dials that can be pre-set is limited to the number of the buttons. Thus, when many users share a fax machine or MFP, it is not possible to set all the frequently used fax numbers, telephone numbers, and/or email addresses to one-touch dials.

### SUMMARY OF THE INVENTION

The present invention provides a method and apparatus for setting user-based one-touch dials in a fax machine or multi-function product (MFP) that a plurality of users share.

According to an aspect of exemplary embodiments of the present invention, there is provided a method of setting user-based one-touch dials in a fax machine or multi-function product (MFP) having a fax function, one-touch dials being differently set according to users.

Users may be identified through user authentication.

According to another aspect of exemplary embodiments of the present invention, there is provided a method of setting user-based one-touch dials in a fax machine or multi-function product (MFP) having a fax function, the method comprising identifying a user, searching a storage unit storing user-based one-touch dial information and then reading one-touch dial information corresponding to the identified user, and matching one-touch dials with keys using the read one-touch dial information.

Each one-touch dial may correspond to at least one of a fax number, a telephone number, and an email address. Identifying a user may comprise receiving an ID and password input from the user, and performing user authentication using the input ID and the password.

The method may further comprise receiving a one-touch dial and a key corresponding to the one-touch dial from the user, and storing the input one-touch dial in an area assigned to the user in the storage unit by matching it with the selected key.

The method may further comprise receiving a key pressed by the user and dialing a fax or telephone number corresponding to the pressed key.

The method may further comprise displaying the user-based one-touch dial information read or printing the user-based one-touch dial information read. The user-based one-touch dial information may be editable.

According to another aspect of exemplary embodiments of the present invention, there is provided an apparatus for setting user-based one-touch dials in a fax machine or multi-function product (MFP) having a fax function, the one-touch dials being differently set according to users. The users may be identified through user authentication.

According to another aspect of exemplary embodiments of the present invention, there is provided an apparatus for setting user-based one-touch dials in a fax machine or multi-function product (MFP) having a fax function, the apparatus comprising a user identification unit for identifying a user, a storage unit for storing user-based one-touch dial information, and a one-touch dial setting unit for searching the storage unit, reading one-touch dial information corresponding to the identified user, and matching one-touch dials with keys using the one-touch dial information read.

Each one-touch dial may correspond to at least one of a fax number, a telephone number, and an email address, and the user identification unit may perform user authentication using an ID and password input by the user.

The one-touch dial setting unit may store a one-touch dial input by the user in an area assigned to the user in the storage unit by matching it with a key selected by the user.

The apparatus may further comprise a display unit for displaying the user-based one-touch dial information read or a printing unit for printing the user-based one-touch dial information read. The user-based one-touch dial information may be editable.

According to an aspect of exemplary embodiments of the present invention, there is provided a computer readable medium having recorded thereon a computer readable program for performing the method of setting user-based one-touch dials.

### BRIEF DESCRIPTION OF THE DRAWINGS

The above and other exemplary features and advantages of the present invention will become more apparent by describing in detail certain exemplary embodiments thereof with reference to the accompanying drawings, in which:

FIG. 1 is a block diagram of an MFP using a method of setting user-based one-touch dials according to an exemplary embodiment of the present invention;

FIG. 2 is a block diagram of an apparatus for setting user-based one-touch dials according to an exemplary embodiment of the present invention;

FIG. 3 is an illustration of a key unit comprising a plurality of keys with which one-touch dials are matched;

FIG. 4 is a flowchart illustrating a method of setting user-based one-touch dials according to an exemplary embodiment of the present invention; and

FIG. 5 is a flowchart illustrating a method of performing one-touch dialing when using an MFP to which user-based one-touch dials are applied according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

FIG. 1 is a block diagram of a multi-function product (MFP) using a method of setting user-based one-touch dials according to an exemplary embodiment of the present invention. The MFP illustrated in FIG. 1 comprises a controller 100, a scanning unit 110, a printing unit 120, a user input unit 130, a display unit 140, a storage unit 150, and a modem 160.

The controller 100 controls all operations of the MFP, the scanning unit 110 reads image data from a document, and the printing unit 120 prints the image data read or image data received from the outside. The modem 160 transmits the image data read or the image data received from the outside to an external device having a facsimile number provided by a user through the user input unit 130. The display unit 140 displays a current state of the MFP or user selectable option values on a screen, and the storage unit 150 stores software required for the controller 100 to control the operation of the MFP or data to be transmitted/printed.

A method of setting user-based one-touch dials according to an exemplary embodiment of the present invention will now be described with reference to FIG. 1. The storage unit 150 stores one-touch dial information for each user using the MFP. In an exemplary implementation, the one-touch dial information can be obtained by one-to-one matching a plurality of keys (not shown) included in the user input unit 130 with fax numbers.

The controller 100 identifies a current user of the MFP, searches the storage unit 150, and reads stored one-touch dial information for the identified user, that is, information on fax numbers corresponding to the keys. The controller 100 one-to-one matches the plurality of keys included in the user input unit 130 with the fax numbers (one-touch dials) based on the one-touch dial information read. In exemplary embodiments the display unit 140 respectively displays the fax numbers corresponding to the keys on a display screen so that the user can see the corresponding one-touch dials.

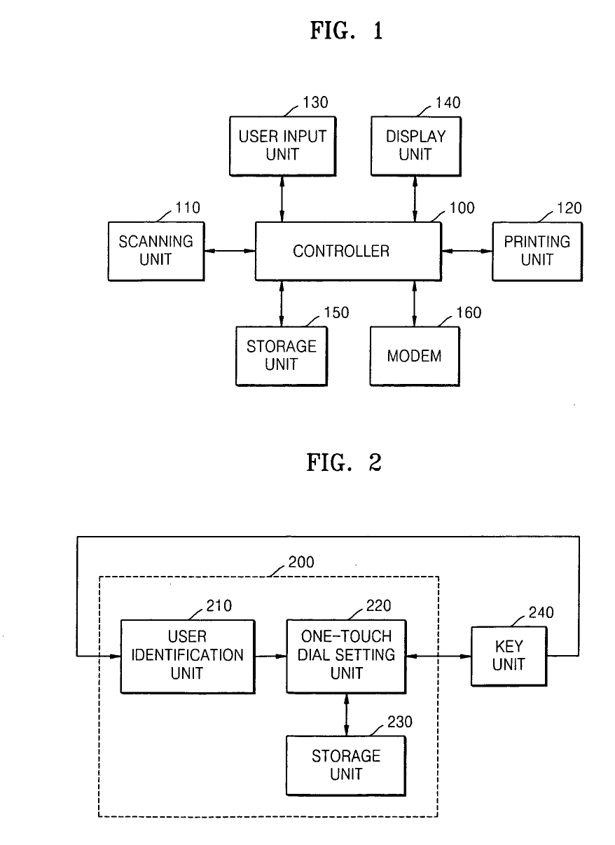

FIG. 2 is a block diagram of an apparatus 200 for setting user-based one-touch dials according to an exemplary embodiment of the present invention. The apparatus 200 illustrated in FIG. 2 comprises a user identification unit 210, a one-touch dial setting unit 220, a storage unit 230, and a key unit 240. An operation of the apparatus 200 illustrated in FIG. 2 will now be described with reference to a method of setting user-based one-touch dials according to an exemplary embodiment of the present invention illustrated in FIG. 4.

In operation 400, the user identification unit 210 identifies a user using the MFP. Certain exemplary embodiments of a method of identifying a user in the user identification unit 210 are described below. In a first exemplary embodiment, users are respectively assigned to a plurality of keys included in a key unit 240 in advance, and if a user presses a key among the plurality of keys, the user identification unit 210 identifiers the user by receiving a signal corresponding to the pressed key from the key unit 240. If a user presses a key assigned to the user twice without delay, the user identification unit 210 identifies the user through the key input.

In a second exemplary embodiment, security is set so that only authenticated users can use the MFP, and the user identification unit 210 identifies a current user of the MFP using user information obtained in a user authentication process. A user inputs an ID and password through the key unit 240 to use the MFP, and the user identification unit 210 performs user authentication on the input ID and password and identifies the user according to the result.

The storage unit 230 stores therein fax numbers, telephone numbers, and email addresses corresponding to the keys included in the key unit 240 for each of the plurality of users. Table 1 illustrates types of user-based one-touch dial information stored in the storage unit 230 as an exemplary implementation accommodating three users.

TABLE 1

| User | Key number | Name | One-touch dial |
|---|---|---|---|
| User 1 | 1 | AAA | 111-1561 |
| | 2 | BBB | 156-4569 |
| | 3 | CCC | ccc@hanmail.net |
| | 4 | DDD | ddd@samsung.com |
| | 5 | EEE | 456-4594 |
| | 6 | FFF | 156-1511 |
| | 7 | GGG | 111-1516 |
| | 8 | HHH | hhh@hotmail.com |
| | 9 | JJJ | 546-1561 |
| | 0 | III | 578-4564 |
| User 2 | 1 | DPG | dfg@yahoo.co.kr |
| | 2 | RTU | 796-1561 |
| | 3 | UYG | 151-1511 |
| | 4 | FED | 789-1561 |
| | 5 | ERT | 664-1519 |
| | 6 | DGV | 861-7894 |
| | 7 | GHJ | ghj@hanmail.net |
| | 8 | JKI | 874-4549 |
| | 9 | SWE | 489-4549 |
| | 0 | RPG | 489-4894 |
| User 3 | 1 | GJK | 444-4564 |
| | 2 | CVB | 165-4599 |
| | 3 | FSX | fsx@hanmail.net |
| | 4 | DPC | dfc@hotmail.net |
| | 5 | DGV | dgv@hanmail.net |
| | 6 | ERT | 489-4849 |
| | 7 | DPG | 679-1165 |
| | 8 | WSX | 789-4564 |
| | 9 | CDE | 756-4564 |
| | 0 | SFD | 789-4894 |

In operation 410, the one-touch dial setting unit 220 reads stored one-touch dial information for the identified user by searching the storage unit 230, and in operation 420, the one-touch dial setting unit 220 matches fax numbers, telephone numbers, and email address with the keys included in the key unit 240 according to the one-touch dial information read. In exemplary embodiments, the storage unit 230 stores not only the user-based one-touch dial information illustrated in Table 1, but also public one-touch dial information commonly used by every user. When a user is not identified, or when a user uses a public one-touch dial, in exemplary embodiments the one-touch dial setting unit 220 reads the public one-touch dial information stored in the storage unit 230 and matches public one-touch dials with the keys.

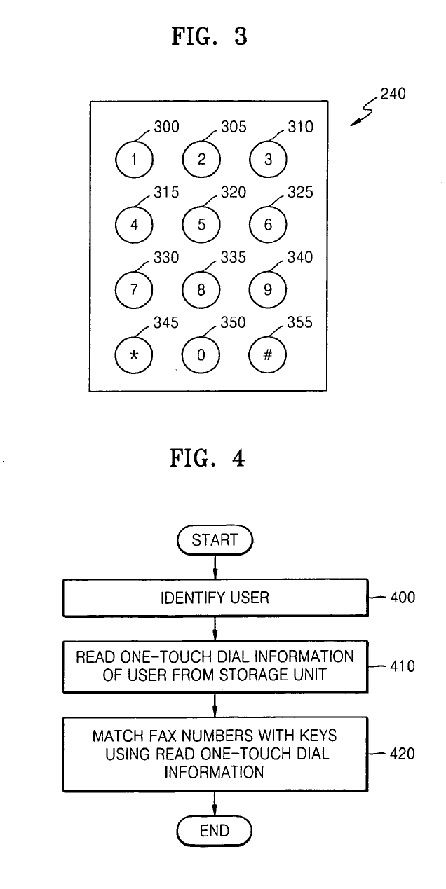

FIG. 3 is an illustration of an exemplary embodiment of a plurality of keys included in the key unit 240. A method of setting one-touch dials to the keys in the one-touch dial setting unit 220 will now be described in more detail with reference to the exemplary embodiments of FIG. 3 and Table 1.

If the user identification unit 210 identifies that a current user of the MFP is user 2, the one-touch dial setting unit 220 reads data related to user 2 among data stored in the storage unit 230 illustrated in Table 1 and matches the fax numbers, telephone numbers, and email addresses with the keys, respectively. That is, the email address “dfg@yahoo.co.kr” named “DPG” corresponds to a “1” key 300, the telephone number “796-1561” named “RTU” corresponds to a “2” key 305, the fax number “151-1511” named “UYG” corresponds to a “3” key 310, and so on for keys “4” through “9,” and “0”, 315-340 and 350 respectively. While one-touch dials are set to the keys 0 to 9 in Table 1, one-touch dials can be set to a “*” key 345 and/or “#” key 355.

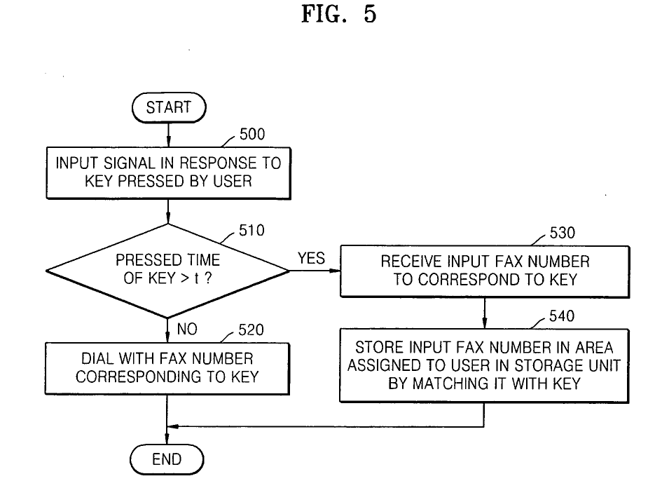

FIG. 5 is a flowchart illustrating a method of performing one-touch dialing when using an MFP to which user-based one-touch dials are applied according to an exemplary embodiment of the present invention. Referring to FIG. 5, in operation 500, the key unit 240 receives a signal in response to a key pressed by a user, and in operation 510, the key unit 240 determines whether the lasting time of the key pressed by the user is longer than t seconds.

If the time duration during which the key is pressed is shorter than t seconds, the key unit 240 receives a fax number corresponding to the key from the one-touch dial setting unit 220 and performs dialing with the received fax number in operation 520. In an exemplary implementation, in operation 520, if a telephone number corresponds to the key, the key unit 240 performs dialing with the corresponding telephone number, and if an email address corresponds to the key, the key unit 240 executes an email transmission application program to transmit an email to the email address.

If the time duration during which the key is pressed is longer than t seconds, the MFP is changed to a one-touch dial setting mode in which a one-touch dial corresponding to the key can be stored. That is, in operation 530, the key unit 240 receives information comprising a fax number, a telephone number, or an email address input by the user and corresponding to the key, and in operation 540, the one-touch dial setting unit 220 stores the information in the storage unit 230 by matching it with the pressed key.

Exemplary embodiments of the present invention may be embodied in a general-purpose computer by running a program from a computer-readable medium, including but not limited to storage media such as magnetic storage media (ROMs, RAMs, floppy disks, magnetic tapes, and so on), optically readable media (CD-ROMs, DVDs, and so on), and carrier waves (transmission over the internet).

As described above, in a method and apparatus for setting user-based one-touch dials according to exemplary embodiments of the present invention, when a fax is transmitted by using a fax machine or MFP that a plurality users share, the number of available one-touch dials can be increased by using a one-touch dial and setting one-touch dials corresponding to the keys for each user.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. A method of setting user-based one-touch dials in a fax machine or multi-function product (MFP) having a fax function, the method comprising setting at least one one-touch dial differently according to at least two users.

2. The method of claim 1, further comprising identifying at least one of the two users through user authentication.

3. A method of setting user-based one-touch dials in a fax machine or multi-function product (MFP) having a fax function, the method comprising:
identifying a user;
searching a storage unit storing user-based one-touch dial information for the identified user;
reading one-touch dial information corresponding to the identified user; and
matching one-touch dials with keys using the one-touch dial information read.

4. The method of claim 3, wherein at least one of the one-touch dials corresponds to at least one of a fax number, a telephone number, and an email address.

5. The method of claim 3, wherein the identifying comprises:
receiving an input ID and password from the user; and
performing user authentication using the input ID and the password.

6. The method of claim 3, further comprising:
receiving a one-touch dial and a key corresponding to the one-touch dial from the user; and
storing the one-touch dial in an area assigned to the user in the storage unit by matching the one-touch dial with the selected key.

7. The method of claim 3, further comprising:
receiving a signal in response to a key pressed by the user; and
dialing a fax or telephone number corresponding to the key.

8. The method of claim 3, further comprising displaying the user-based one-touch dial information.

9. The method of claim 3, further comprising printing the user-based one-touch dial information.

10. The method of claim 3, wherein the user-based one-touch dial information comprises editable information.

11. An apparatus for setting user-based one-touch dials in a fax machine or multi-function product (MFP) having a fax function, the apparatus comprising at least one one-touch dial configured to be differently set according to at least two users.

12. The apparatus of claim 11, wherein the users are identified through user authentication.

13. An apparatus for setting user-based one-touch dials in a fax machine or multi-function product (MFP) having a fax function, the apparatus comprising:
a user identification unit for identifying a user;
a storage unit for storing user-based one-touch dial information; and
a one-touch dial setting unit for searching the storage unit, reading one-touch dial information corresponding to the user identified by the user identification unit, and matching one-touch dials with keys using the one-touch dial information.

14. The apparatus of claim 13, wherein at least one of the one-touch dials corresponds to at least one of a fax number, a telephone number, and an email address.

15. The apparatus of claim 13, wherein the user identification unit performs user authentication using at least one of an ID and password of the user.

16. The apparatus of claim 13, wherein the one-touch dial setting unit is configured to store a one-touch dial input by the user in an area assigned to the user in the storage unit by matching the one-touch dial input with a key selected by the user.

17. The apparatus of claim 13, further comprising a display unit for displaying the user-based one-touch dial information.

18. The apparatus of claim 13, further comprising a printing unit for printing the user-based one-touch dial information.

19. The apparatus of claim 13, wherein the user-based one-touch dial information comprises editable information.

20. A computer readable medium having recorded thereon a computer readable program for performing the method of claim 1.

21. A computer readable medium having recorded thereon a computer readable program for performing the method of claim 3.
